(19) United States
(12) Patent Application Publication
(10) Pub. No.: US 2015/0251707 A1
(43) Pub. Date: Sep. 10, 2015

(54) Component, at least Sections of Which are Formed from a Fiber Composite, in the Chassis Region of a Vehicle

(71) Applicant: Bayerische Motoren Werke Aktiengesellschaft, Muenchen (DE)

(72) Inventor: David KELLER, Muenchen (DE)

(21) Appl. No.: 14/718,240

(22) Filed: May 21, 2015

Related U.S. Application Data
(63) Continuation of application No. PCT/EP2013/073641, filed on Nov. 12, 2013.

(30) Foreign Application Priority Data
Nov. 22, 2012 (DE) 10 2012 221 405.4

(51) Int. Cl. B62D 29/04; B29C 70/42; B29C 70/54; B62D 25/20

(52) U.S. Cl. CPC B62D 29/041; B62D 25/2009; B29C 70/42; B29C 70/54; B29K 2105/0881

(57) ABSTRACT

A component is provided, at least sections of which are formed from a fiber composite. The component may be for a chassis region of a motor vehicle, and includes a section designed for an overload in respect of tensile loading. The overload section is formed by a flat strip folded in a plurality of layers one above another, or by an open or closed profile of a semi-finished fiber product or a fiber composite, wherein the profile overlaps in a plurality of cohesive layers which are connected to one another via the plastics matrix of the fiber composite.

### CROSS REFERENCE TO RELATED APPLICATIONS

This application is a continuation of PCT International Application No. PCT/EP2013/073641, filed Nov. 12, 2013, which claims priority under 35 U.S.C. §119 from German Patent Application No. 10 2012 221 405.4, filed Nov. 22, 2012, the entire disclosures of which are herein expressly incorporated by reference.

### BACKGROUND AND SUMMARY OF THE INVENTION

The invention relates to a component, at least sections of which are formed from a fiber composite. The component has a section which is designed for an overload in respect of tensile loading. Preferably, but not obligatorily, a component according to the invention can be used in the chassis region of a vehicle, for example in the form of a wheel-guiding link or the like.

In motor vehicle manufacturing, overload mechanisms are produced, for example, in the chassis by local failure (for example buckling) of links, struts or the like, or, in the event of an accident, also by detachment or shearing off of connecting elements, such as rubber joints or the like. Such overload mechanisms can only partially be produced in components which are formed from fiber composite plastics, which components will be increasingly used in the future. This is because, in particular, plastics which are reinforced with endless fibers do not exhibit any plastic behavior. The behavior in the event of an accident or in the event of an overload is binary in nature for such materials, in particular in the tensile load path, that is to say, there is typically an abrupt transition between complete support behavior and the complete failure. However, this is undesirable, for example, in the case of a wheel-guiding link. On the contrary, a wheel-guiding link which is subjected to an overloading stress is intended to still be able partially to guide said wheel, even if not exactly in the original position. Furthermore, only a few correcting variables are available for a specific configuration of the load-supporting behavior after or during a damage event.

It is therefore the object of the present invention to provide a component, at least sections of which are formed from a fiber composite, which component has a section designed for an overload in the tension direction, in respect of tensile loading and, in the event of a certain overload which is limited in terms of magnitude, i.e. is not extremely high, does not abruptly completely fail, but rather is capable of carrying out its function to at least a small extent.

This object is achieved by a component, at least sections of which are formed from a fiber composite, for example of a vehicle, and which is provided there in particular in the chassis region, which component has a section which is designed for an overload in respect of tensile loading. The section is formed by a flat strip folded in a plurality of layers one above another, or by an open or closed profile of a semi-finished fiber product or a fiber composite. The profile overlaps in a plurality of cohesive layers, with a horizontal fiber flow in the direction of the tensile loading, which layers are connected to one another via the plastics matrix of the fiber composite. Said section with the, according to the invention, plurality of overlapping and cohesive layers which, in the case of a profile, are also folded in practice, is also referred to below as the “overlapping region” or “overlapping section”.

According to the invention, overlaps of the substantially unidirectional fibers are provided in the component, wherein the fibers are designed as endless fibers and are substantially oriented in the direction of the tensile loading of the component. In the overlapping region, the fibers have virtually the shape of an S course, as viewed from the side, i.e. said fibers within the widest sense describe the letter “S”, for example in such a manner that a fiber which, for example, is introduced horizontally from the right is guided upward in a vertical plane in a 180° arc and initially runs to the right again for a certain section in order then to be further guided upward horizontally to the left in a further 180° arc. It can then be provided that first of all only a semi-finished fiber product (=“dry” laid scrim or the like with a multiplicity of unidirectional reinforcing fibers, for example composed of carbon, running parallel to one another) is correspondingly laid and, by adding the plastics matrix, is formed into the component, or that a prepared fiber composite with unidirectional reinforcing fibers (for example, in the form of “prepregs”) is correspondingly laid in order to subsequently correspondingly manufacture the component. In both cases, the layers of said parallel reinforcing fibers that are folded one above the other are connected to one another in the overlapping region, specifically via the plastics matrix, which forms the component overall, of the fiber composite.

With such a configuration, when a tensile overload occurs in the tension direction, a component configured according to the invention can be, as it were, unfolded and therefore does not tear or break abruptly apart, but rather the section or overlapping region which is designed for an overload in respect of tensile loading continues to connect the component parts which are customarily located on both sides of said section to one another, even after tearing open or unfolding in the overlapping region. Therefore, said component can continue to at least partially carry out its function in particular of transmitting tensile force even after such an overload event. As a consequence of the configuration according to the invention, a weight reduction in relation to a possible alternative, namely the installation of a separate overload component from the prior art, can therefore be obtained and, furthermore, very high energy absorption can advantageously be achieved.

The force/displacement behavior of the overlapping region can be set within wide ranges independently of each other for normal use and for the overload behavior by way of the selection of the width of the strip of reinforcing fibers or fiber composite or by way of a suitable selection of the profile cross section and the overlapping length. Of particular advantage here is the stepwise failure of a component according to the invention in the section thereof which is designed for an overload, which, in a particularly advantageous development, can also take place in a plurality of steps by a plurality of overlaps being provided.

According to an advantageous development, the overlapping region can be reinforced by intermediate layers and/or sewn structures. By this measure, the force/displacement behavior in the event of an overload can likewise be influenced to a wide extent. In the case of a sewn structure, the at least two semi-finished fiber products lying one above to other in the overlapping region, or layers of fiber composite, are connected fixedly to one another, for example non-positively, in particular by an additional connection at the fibers, specifically, for example, by sewing, stitching or tufting or by clips or the like. However, a reinforcement can also be formed by an intermediate layer between two cohesively overlapping layers of reinforcing fibers (in the form of a semi-finished fiber product or in the form of a fiber composite). The intermediate layer is intended preferably to be drawn out of the overlapping region into the adjoining region of the component and is also intended to be connected outside the overlapping region to the other fiber layers. In principle, the overlapping length of each folded layer in the overlapping region can be identical. Alternatively, however, the overlapping length of each folded layer in the overlapping region can also be different.

A suitable filling material can be placed into the folds or in the folds of the section or overlapping region which is designed for an overload in respect of tensile loading, which filling material may be beneficial for unfolding in the event of an overload and can furthermore serve to avoid breaking of fibers. Such a filling material can be, for example, a roller, with the axis thereof extending transversely with respect to the respective reinforcing fibers, or a flexible tube, but alternatively also a sheet-like layer, for example, made of silicone or Teflon, which materials prevent the overlapping layers of fiber composite from sticking together in the bending fold which is provided for producing the cohesive overlap. The failure behavior, i.e. the breaking open of the overlap, in the event of a certain overload can therefore be set in a targeted manner.

It has already been mentioned that a component designed according to the invention can be, for example, a wheel-guiding link in the chassis of a motor vehicle. Of course, other components which are subjected to a tensile load and which, in the event of an overload, are not intended to tear apart completely in an abrupt manner can also be configured in a corresponding manner. Returning to a wheel-guiding link, it is already known that the latter can be shaped in a manner not only extending linearly, but also approximately in a step-like manner, wherein then one said section or overlapping region can be provided in each of the various steps. Furthermore, such a link with an overlapping region can be constructed from various individual parts, namely from a prefolded piece which forms the overlapping region and to which an end piece is attached on both sides, via which the link is connected to a further component. The end pieces can be composed, for example, of an injection molded part or fiber composite molded composition and can be connected, for example, in an integrally bonded manner to the piece forming the overlapping region. Alternatively, however, the end pieces can also be composed of metallic materials.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a strip of a semi-finished fiber product or fiber composite with the overlapping region according to an embodiment of the invention (with a plurality of layers of said strip);

FIG. 2 is a side view of the illustration in FIG. 1;

FIG. 3 is a side view of an embodiment of layers of semi-finished fiber product strips or fiber composite strips in the respective overlapping region;

FIG. 4 is a side view of an embodiment of layers of semi-finished fiber product strips or fiber composite strips in the respective overlapping region;

FIG. 5 is a side view of an embodiment of layers of semi-finished fiber product strips or fiber composite strips in the respective overlapping region;

FIG. 6 is a side view of an embodiment of layers of semi-finished fiber product strips or fiber composite strips in the respective overlapping region;

FIG. 7 is a side view of an embodiment of layers of semi-finished fiber product strips or fiber composite strips in the respective overlapping region;

FIG. 8 is a side view of an embodiment of layers of semi-finished fiber product strips or fiber composite strips in the respective overlapping region;

FIG. 9 is a schematic diagram of a possible arrangement of a component according to an embodiment of the invention in a chassis of a vehicle;

FIG. 10 is a refinement according to an embodiment of the invention, in which, instead of a strip, a profile is laid in a plurality of layers in an overlapping region;

FIG. 11 illustrates a further possible refinement of a profile which can be laid analogously to FIG. 10; and

FIG. 12 is a three-dimensional partial sectional illustration of a closed profile which has an overlapping region according to an embodiment of the invention.

### DETAILED DESCRIPTION OF THE DRAWINGS

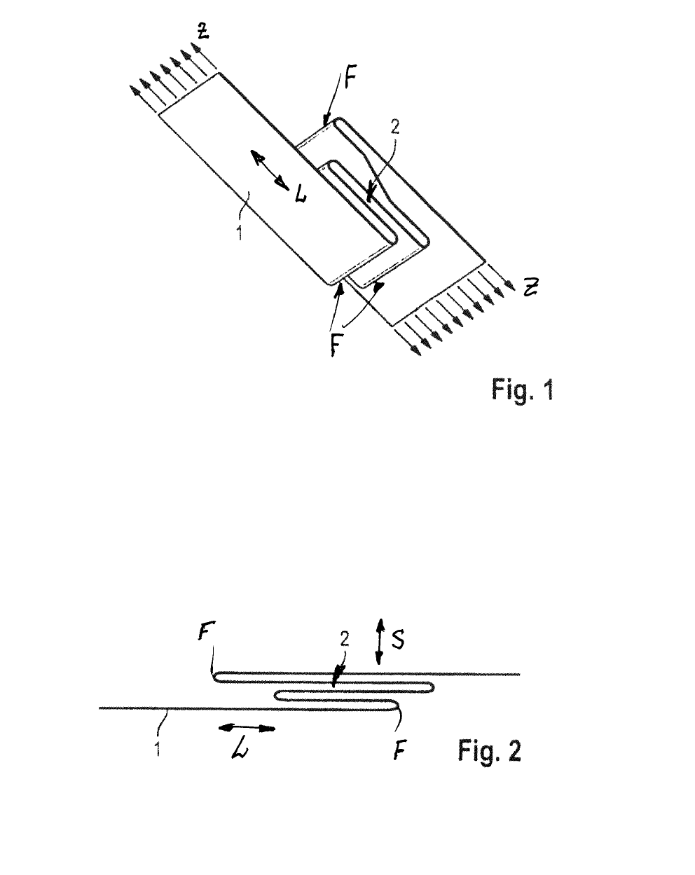

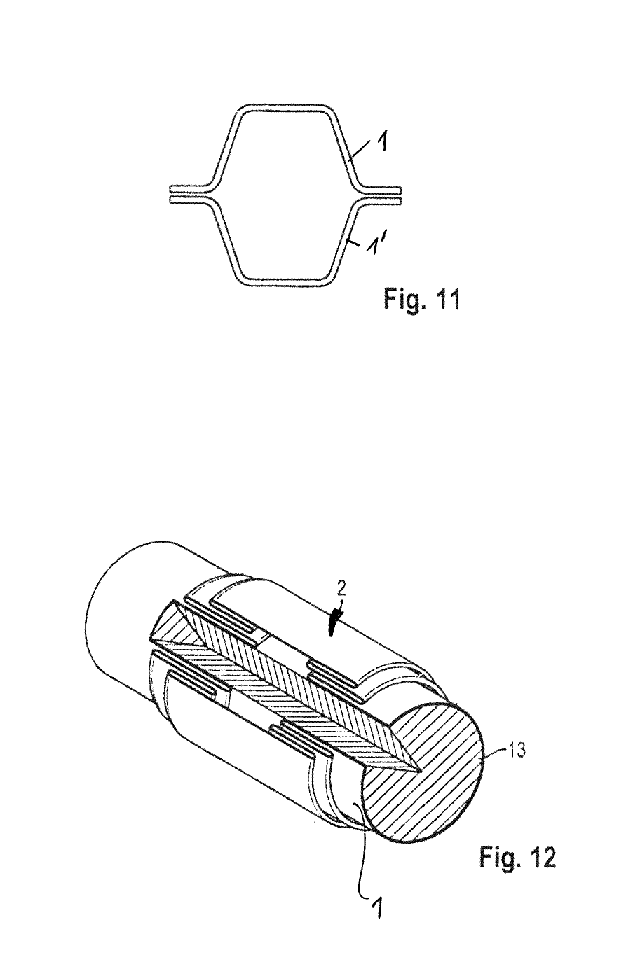

FIGS. 1-8 and FIGS. 10-12 illustrate part of a component according to embodiments of the invention, which component can serve, for example, as a tension strut in a motor vehicle. The tension strut, for its part, is able to be used as a wheel-guiding link. The component has, for example, a flat strip (see FIG. 1), an open profile (see FIG. 10) or a closed profile (see FIGS. 11 and 12) consisting, in each case, of a unidirectionally reinforced fiber composite 1 or, alternatively, a corresponding semi-finished fiber product 1, with unidirectionally running reinforcing fibers, for example composed of carbon. The fiber composite 1 or the semi-finished fiber product 1 is folded in a plurality of layers one above the other in what is referred to as an overlapping region 2. The individual layers (or layer bundles) therefore form the respective overlapping region 2, into which a plurality of folds of individual layers or of a plurality of layers which are cohesive per se either of semi-finished fiber product or of fiber composite which is initially still not solidified have been or are deposited in a manner stacked one above another. The layers are formed by folds of the material and, as viewed in the longitudinal direction L of the strip of the fiber composite 1 (cf. FIG. 1), are connected cohesively to one another via the folds F arising during the folding process. Furthermore, the five layers of fiber composite 1 or semi-finished fiber product 1 that overlap in FIG. 1 are connected to one another in the overlapping region 2 in the direction S which is perpendicular to the strip 1 (see FIG. 2), specifically via the plastics matrix of the fiber composite.

Within the strip 1 of fiber composite or semi-finished fiber product, the reinforcing fibers, which are formed, for example, from carbon, preferably extend here unidirectionally in the longitudinal direction L of the strip 1. The reinforcing fibers located next to one another are held together by braiding threads which run at an angle to the reinforcing fibers and can be formed, for example, from glass fibers. Furthermore, FIG. 1 illustrates, by means of arrows Z which extend in the longitudinal direction L of the illustrated strip of fiber composite 1, the tensile loading of the component or of the strip 1 located therein. This tensile loading is directed in the same direction as the direction of extent of the reinforcing fibers which are provided in the component or strip and are formed by endless fibers. In the event of a tensile overload of the relevant component, the overlapping region 2 or of the strip 1 is, as it were, unfolded in the direction of the arrows Z.

Of course, a component can be formed by a plurality of such strips 1 of fiber composite, which strips, for their part, can also lie one above another, again as viewed in the arrow direction S. Furthermore, of course, cover layers can be provided above and below the strip 1 (illustrated figuratively) of semi-finished fiber product or fiber composite, which cover layers, for their part, can be composed of one or more layers of fiber-reinforced plastics, for example from unidirectional laid scrims, braids, woven fabrics or other textile semi-finished products.

Furthermore, additional open ends of further layers of fiber composite or semi-finished fiber product can be placed into the region of the folds of the strip 1 of fiber composite, as is explained and illustrated in the following. Furthermore, individual layers or a plurality of said layers can be sewn, tufted or stitched together by means of a different textile process or by means of clips at points in particular in the overlapping region 2 by use of threads in the thickness direction (arrow direction S). The stitchings can relate basically both to the overlapping region 2 and also to sections on the far side of the overlapping section 2 of the component.

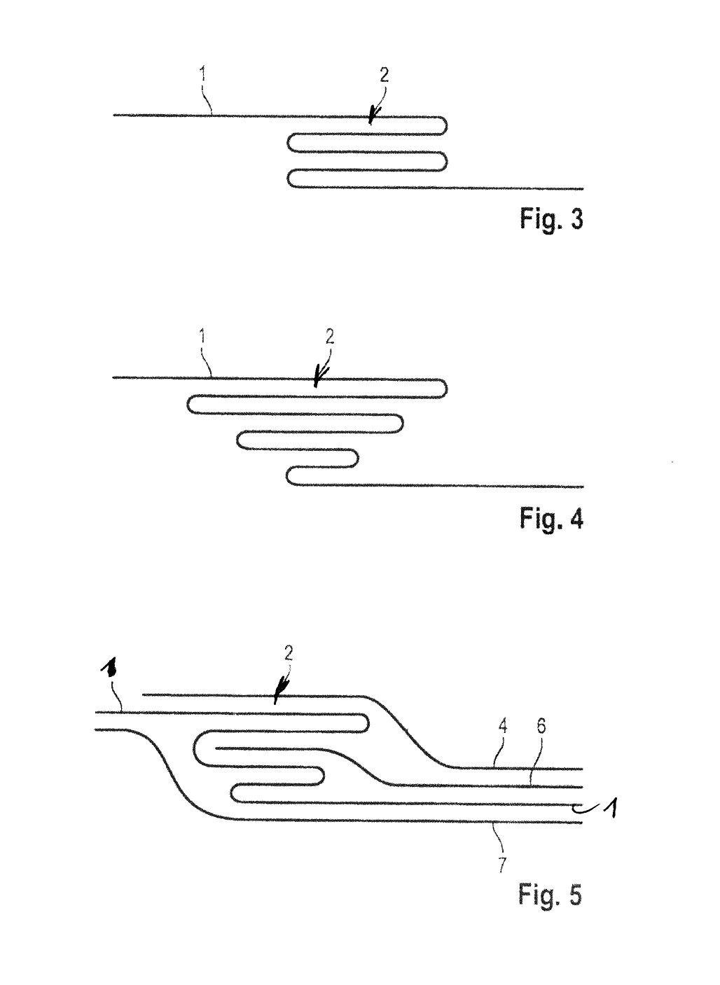

FIGS. 3 to 8 show, in greatly abstract form, various embodiments as to how the layers (here in the form of strips 1) of semi-finished fiber product or fiber composite can be arranged.

According to FIG. 3, the overlapping length of the layers in the overlapping region 2 is identical. According to FIG. 4, the overlapping length differs. FIG. 8 shows a construction with two overlapping regions 2 incorporated one in the other and consisting of two folded layers 1, 1′ of fiber composite or semi-finished fiber product.

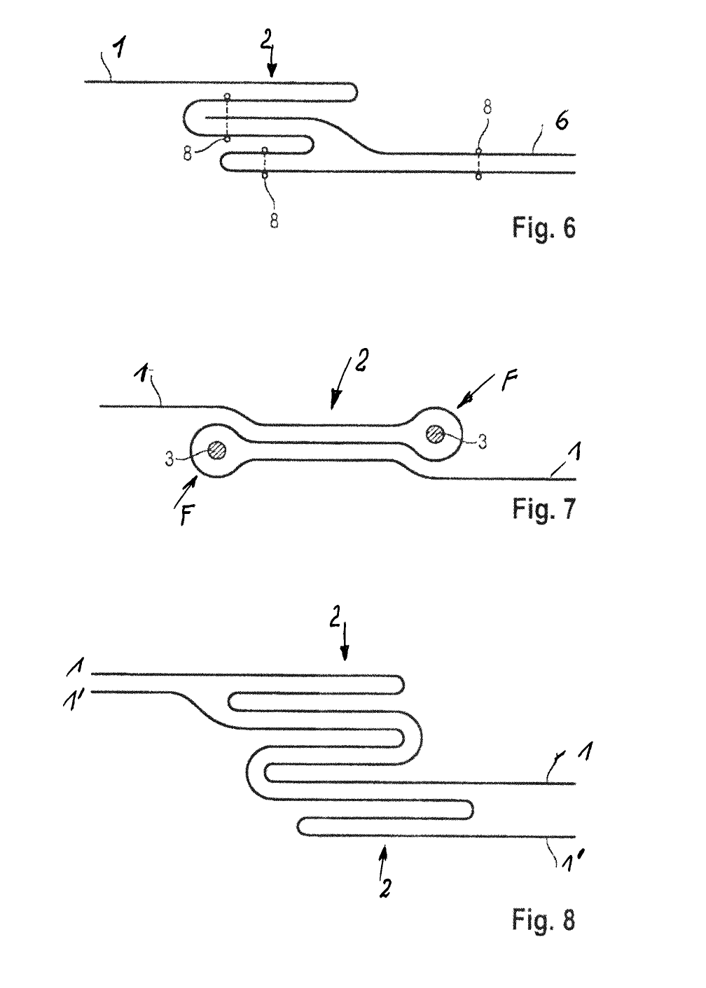

FIG. 5 shows an embodiment with an upper cover layer 4, a layer 1 which is folded according to the invention, an inserted intermediate layer 6 and a lower cover layer 7, which are in each case formed by a semi-finished fiber product or fiber composite in the form of a prepreg or the like. FIG. 6 shows a similar construction to FIG. 5, but with sewn structures 8 in different regions.

According to FIG. 7, in the overlapping region 2, in the folded layer 1, additional filling materials 3 are placed into the fold F or in the point thereof. The filling materials 3 ensure a greater radius of curvature of the folded strip 1 and can therefore guard against an undesirable early failure as a consequence of breaking of fibers. Suitable filling materials 3 are basically the same materials as for cover layers, but in particular also short-fiber, band-like or string-like configurations of laid fiber scrims or the like. If, by contrast, a material which is not connected to the plastics material of the fiber composite is used for the filling material 3, the filling material is particularly beneficial for unfolding the overlapping region 2 in the event of a tensile overload of the component in question.

A component designed according to the invention can be used as a load-supporting strut, for example, in the chassis region of a vehicle. The struts can be arranged movably here, for example, in the wheel guide (=links). Intersections with adjacent components are then predominantly produced via joints or constructions which are flexible in another manner (for example, in the form of a film hinge). Alternatively, such components can be used as rigid struts in the vehicle, such as, for example, as cross struts in axle supports or between an axle support and the body. The components configured according to the invention can be mounted as individual components or integrated parts, such as an articulated axle system, for example an axle support with integrated plastics links. Predominantly in regions where, in the event of an overload or accident (for example, head-on crash of the vehicle, but also when traveling over obstacles), high, possibly abrupt tensile load peaks occur which are intended to be dissipated via a targeted failure of components, a component configured according to the invention with at least one fiber composite layer 1 folded in at least one overlapping region 2 can be used.

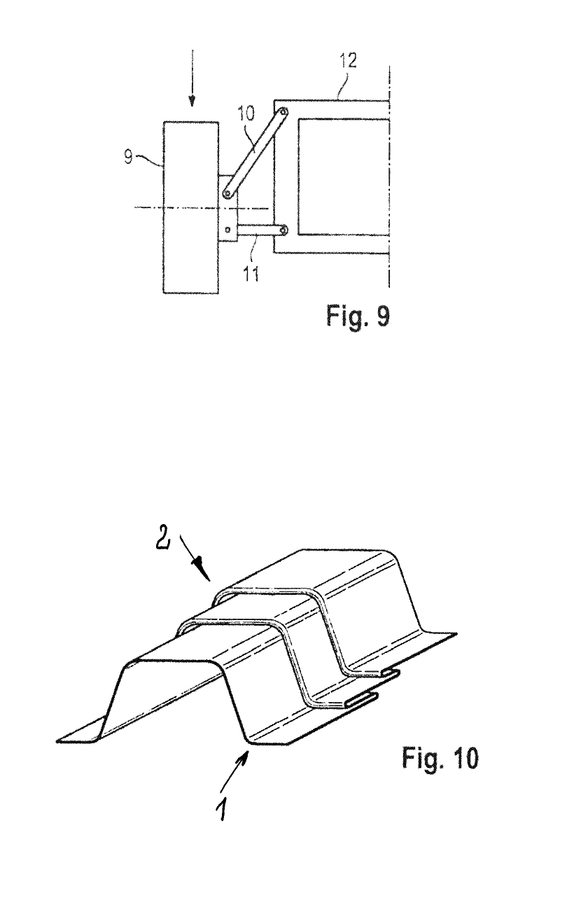

FIG. 9 shows such a use as a tensile load element in the chassis of a motor vehicle. The wheel 9 of the vehicle is fastened to an axle support 12 via a tension strut 10 and a compression strut 11. The joints between axle support 12 and struts 10, 11 or between struts 10, 11 and the wheel support of the wheel 9 can also be produced by flexible constructions. As a result, the respective strut 10, 11 becomes an integral part of a, for example, an A-arm, axle support or wheel support.

Components with an overlapping region 2, which is configured according to the invention and in respect of an overload, can be designed as profile- or band-like parts with a filled (monolithic) cross section, wherein the cross section can be configured variably over the length of the part. In order to meet, for example, requirements regarding flexural rigidity from the operation, it may be expedient to produce the cross sections also as open profiles (for example, U profiles) or, by adhesively bonding half shells or by way of braids, also as closed profiles. The longitudinal axis of the respective profile primarily extends here along tensile loading directions.

FIGS. 10 and 11 show exemplary configurations of profiles which are composed of the fiber composite 1 according to the invention. FIG. 10 shows a hat-shaped or U-shaped cross-sectional profile with integrated overlapping regions 2, FIG. 11 shows a closed profile consisting of two half shells 1, 1′ which are joined to each other. The two half shells 1, 1′ here can be, for example, sewn, adhesively bonded, riveted, screwed, welded (in the case of thermoplastic) or connected by co-curing, that is to say during joint manufacturing, in an injection operation.

FIG. 12 shows a three-dimensional partial sectional illustration of a closed hollow profile consisting of a core 13 which is circular-cylindrical here and on which a layer 1 of semi-finished fiber product or fiber composite is applied in a manner according to the invention, namely with an overlapping region 2. The hollow profile can be produced by braiding of the core 13, wherein the braiding direction is revolved a number of times in the overlapping region 2.

Although up to now only carbon fibers have been mentioned as reinforcing fibers, the fiber composite used within the scope of the present invention can nevertheless be any endless fiber reinforced plastic with, for example, carbon fibers, glass fibers, aramid fibers or basalt fibers, and, furthermore, the cover layers used can also be nonwovens or fiber mats consisting of random fibers, and, furthermore, recycled endless fibers or combinations of the above materials. The plastics used can be equally thermoplastics or thermosetting plastics, and, of course, also SMCs (preimpregnated prepregs with nonwoven fabric).

Cores (as shown in FIG. 12 under reference number 13) or filling material (as shown in FIG. 7 under reference number 3) as process agents can be removed in a later working step or else can remain in the component configured according to the invention. In the case of closed profiles, lightweight, thrust-resistant cores, in particular foam or blown cores, can be removed subsequently by washing out or finishing in some other manner in order to obtain a hollow or partially hollow profile.

Whereas, during the normal operating state of a component according to the invention, the properties thereof are substantially determined by the fiber properties and, of course, by the configuration, in particular on the far side of the overlapping region 2, in the event of an overload of the component, a peeling mode or delamination mode is set into operation, in which the stack of layers 1 lying one above another, which stack is initially folded in the overlapping region 2, is gradually unwound. The force/displacement behavior of said unwinding process can be additionally influenced here by optionally inserted intermediate layers (“filling material”) and/or sewn structures. This “failure function” of the component configured according to the invention is achieved in the event of tensile loads above a certain design limit. Crucial damage phenomena include delaminations in the region of the folds F, possibly in combination with failure of optionally provided binding or sewing threads. As a result, in the dynamic case, the folds are unwound one after another.

Over the course of such development of damage to the component, i.e. during such an unwinding process, energy (for example, originating from a vehicle crash) is advantageously dissipated. The energy dissipation occurs in a plurality of phases, namely an initial phase, in which a first damage is caused, furthermore, in a second phase, the time profile of the dissipated energy is in a direct relationship with the surface of fracture becoming free by “unwinding” of the overlaps. As a result, the geometrical dimensions of the fold overlaps are basically available for the design of the component. In the final phase of the energy dissipation, the energy is brought about by local and finally global failure of the fiber layers. The fiber failure can also be set in a targeted manner by different lengths of the overlaps in the overlapping region 2. The combination of geometrical configuration, fiber architecture and material combination is responsible here for achieving a desired failure function.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component having at least one section formed of a fiber composite, the component comprising:
an overload section of the component configured for an overload in respect of tensile loading, wherein
the overload section comprises one of (i) a flat strip of semi-finished fiber product or fiber composite folded in a plurality of layers one above another and connected to one another via a plastics matrix, or (ii) an open or closed profile of semi-finished fiber product or fiber composite, the profile overlapping in a plurality of cohesive layers connected to one another via a plastics matrix.

2. The component according to claim 1, further comprising:
an additional fixed connection in the overload section, the additional fixed connection being between at least two of the layers that are folded one above another or overlap.

3. The component according to claim 2, wherein the additional fixed connection is one of a sewn, tufted, stitched or clipped connection.

4. The component according to claim 1, further comprising an intermediate layer configured to reinforce the overload section.

5. The component according to claim 1, wherein an overlapping length of each folded layer in the overlap section is identical.

6. The component according to claim 1, wherein an overlapping length of each folded layer in the overload section is different.

7. The component according to claim 1, further comprising a filling material arranged in folds of the overload section.

8. The component according to claim 1, wherein the component is a vehicle component for a chassis region of a vehicle.

9. The component according to claim 8, wherein the component is a wheel-guide link in the chassis of the vehicle.

10. The component according to claim 9, wherein the wheel-guide link is configured in a stepped manner rather than linearly, an overload section being arranged in one or more of the steps.

11. A vehicle component, comprising:
a flat strip of semi-finished fiber product or fiber composite, the flat strip comprising an overlapping region in which a plurality of layers of the flat strip are folded one above another in a predetermined manner and connected via plastics matrix to provide a defined overlapping region configured for a tensile overloading of the component.

12. The component according to claim 12, wherein the vehicle component is a wheel-guide link in a chassis region of a motor vehicle.

13. A vehicle component, comprising:
a fiber composite or semi-finished fiber component having an open or closed profile, the profile of the component comprising an overlapping region in which cohesive layers of the fiber composite or semi-finished fiber overlap one another and are connected to one another via plastics matrix in order to provide a defined overload section for tensile overloading of the vehicle component.

14. The component according to claim 13, wherein the vehicle component is a wheel-guide link in a chassis region of a motor vehicle.
